(19) United States
(12) Patent Application Publication
(10) Pub. No.: US 2024/0068593 A1
(43) Pub. Date: Feb. 29, 2024

(54) INTERFACE ADAPTER FOR A CONTROL VALVE AND CONTROL VALVE WITH AN INTERFACE ADAPTER

(71) Applicant: KNORR-BREMSE SYSTEME FÜR SCHIENENFAHRZEUGE GMBH, Munich (DE)

(72) Inventors: Istvan HEGEDÜS, Györ (HU); Balazs LIKTOR, Budapest (HU); Jens-Erik PIEPER, Munich (DE)

(21) Appl. No.: 18/280,331

(22) PCT Filed: Feb. 17, 2022
(86) PCT No.: PCT/EP2022/053924

§ 371 Date: Sep. 5, 2023

(30) Foreign Application Priority Data
Mar. 5, 2021 (EP) 21160855.9

(51) Int. Cl. F16K 37/00; B60T 15/02; B60T 17/22

(52) U.S. Cl. CPC F16K 37/0091; B60T 15/021; B60T 17/221

(57) ABSTRACT

An interface adapter for a control valve of a rail car pneumatic brake system, wherein the control valve has at least two housing compartments being in fluid communication with each other via a fluid interface, includes a fluid interface duplicate for enabling fluid communication between the housing compartments through the interface adapter and a further interface being in fluid communication with the fluid interface duplicate for enabling access to the fluid communication between the housing compartments from outside the housing.

### CROSS REFERENCE AND PRIORITY CLAIM

This patent application is a U.S. National Phase of International Patent Application No. PCT/EP2022/053924 filed Feb. 17, 2022, which claims priority to European Patent Application No. 21160855.9, the disclosure of which being incorporated herein by reference in their entireties.

### FIELD

Disclosed embodiments relate to an interface adapter for a control valve, particularly for a rail car pneumatic brake system, and to a control valve, comprising such an interface adapter.

### BACKGROUND

Control valves in a pneumatic brake system have to react precisely to changes in the brake pipe pressure and to provide the corresponding brake cylinder pressure. Modern pneumatic brake systems use electric valves that receive braking signals by wire or radio to control the airflow to and from the brake cylinder. In order to provide a safely functioning and reliable pneumatic brake system, the valves and the pipe system connected to the valves need to be monitored and checked.

### SUMMARY

An interface adapter for a control valve, particularly of a rail car pneumatic brake system, according to the disclosed embodiments, is configured to be integrated in a control valve having at least two housing compartments. The interface adapter enables a modular construction of the control valve, when an additional housing compartment or module with an interface that is not compatible with a standardized interface of the existing control valve, needs to be integrated in the control valve.

### BRIEF DESCRIPTION OF THE FIGURES

The following detailed description refers to the accompanying drawings. The same reference numbers may be used in different drawings to identify the same or similar elements. In the following description, for purposes of explanation and not limitation, specific details are set forth such as particular structures, functionality, etc. in order to provide a thorough understanding of the various disclosed embodiments.

However, it will be apparent to those skilled in the art having the benefit of the present disclosed embodiments may be practiced in other examples that depart from these specific details. In certain instances, descriptions of well-known devices and methods are omitted so as not to obscure the description of the disclosed embodiments with unnecessary detail.

FIG. 1 shows an example embodiment of a control valve according to disclosed embodiments comprising an interface adapter configured to implement a monitoring system.

FIG. 2 shows the control valve in FIG. 1 from the back.

FIG. 3 shows the interface of the monitoring system that is not compatible with the fluid interface of the control valve.

FIG. 4 shows a schematic view of an interface adapter according to the disclosed embodiments.

### DETAILED DESCRIPTION

As indicated above, modern pneumatic brake systems use electric valves that receive braking signals by wire or radio to control the airflow to and from the brake cylinder. In order to provide a safely functioning and reliable pneumatic brake system, the valves and the pipe system connected to the valves need to be monitored and checked. For such an electric controlled brake system, EP 3 608 184 A1 proposes a valve diagnostic and monitoring system, especially for a distributor valve in a pneumatic brake system for rail cars. The monitoring system can monitor and check different parameters, especially different pressures in the control valve and the pipe system that is in fluid communication with the control valve.

The referenced solution only gives a general overview of such a diagnostic and monitoring system, but there is no concrete mechanical implementation of the concept within the control valve or a solution on how to implement the monitoring system into the control valve. The downside of the solution is further that the monitoring system is configured to be used with a new generation of control valves and has an interface that is adapted to the new generation of control valves. Existing control valves have standardized interfaces to which the interface of the new monitoring system is not compatible. Thus, the monitoring system cannot be used as a retrofit solution to upgrade existing control valves. Another problem is that, especially in rail car pneumatic brake systems, the installation space for the control valve is limited, making it difficult to integrate the monitoring system without interference with the control valve or other components next to it. It is an object of the disclosed embodiments to overcome the above-mentioned disadvantages of the state of the art, particularly to provide a mechanical solution to integrate the monitoring system in existing control valves as a retrofit solution and to provide a standardized interface across all valve products, optionally in order to gain easy access to all pressures that need to be monitored by the monitoring system to provide a reliable pneumatic brake system.

An interface adapter for a control valve, particularly of a rail car pneumatic brake system, according to the disclosed embodiments, is configured to be integrated in a control valve having at least two housing compartments. The interface adapter enables a modular construction of the control valve, when an additional housing compartment or module with an interface that is not compatible with a standardized interface of the existing control valve, needs to be integrated in the control valve. Optionally, the interface adapter is placed between the two housing compartments of the control valve. The housing compartments and/or the additional module or housing compartment can be connected to the interface adapter, optionally in an easy detachable way, for example by screws. The interface adapter can be made out of steel, aluminum, polymer or other material to be suitable for working temperatures between −50° C. and 70° C.

The control valve can also comprise one ore more further housing compartments. The housing compartments can be rearranged or exchanged easily, providing a modular construction of the control valve. The housing compartments can be connected to each other, optionally in an easy detachable way. Each housing compartment can comprise or be connected to one or more modules of the control valve. These modules may include but are not limited to a valve arrangement, such as a distributor valve or a relay valve arrangement, or an electronic module, such as a monitoring system. The relay valve arrangement may comprise one or more relay valves. Such a modular construction has the advantage that the control valve can be adapted flexibly to potential requirements and that all modules requiring maintenance are easy detachable. The housing compartments can be made out of steel, aluminum, polymer or other material to be suitable for working temperatures between −50° C. and 70° C. In an example embodiment the control valve comprises a first housing compartment, in particular a valve bracket, that does not comprise and is not connected to a module of the control valve. Instead the valve bracket my be connected to one or more further housing compartments. The further housing compartments each can comprise or can be connected to a module of the control valve, such as a distributor valve, a relay valve arrangement or an electronic module. In this embodiment the interface adapter is optionally placed between the valve bracket and the other housing compartments each comprising or connected to a module of the control valve, such as a distributor valve, a relay valve arrangement or an electronic module.

The at least two housing compartments of the control valve are in fluid communication with each other via a fluid interface. Via this fluid interface the fluid of the brake system, in particular the air stream, can pass from one housing compartment to the other housing compartment. As the control valve can comprise more than two housing compartments, the fluid interface can be designed to enable fluid communication between more than two housing compartments, optionally between all housing compartments. Further, there can be more than one fluid interface wherein each fluid interface enables fluid communication between two housing compartments, in particular to enable fluid communication between all housing compartments. Optionally each housing compartment comprises at least one fluid interface. The fluid interface can be realized by at least one fluid inlet or outlet. The fluid interface can also comprise one or more further fluid inlets and/or outlets. Optionally at least one housing compartment has further fluid inlets and/or outlets to enable fluid communication with other components of the brake system. This fluid communication can be realized by a pipe system. For example the pipe system connects the control valve with the brakes, wherein the brake pipe leads the air stream from the control valve to the brakes, as well as the emergency reservoir, the auxiliary reservoir and the brake cylinder, wherein the pipes lead the air stream to the control valve. In this example the fluid interface between the housing compartments guides the air stream, coming into the valve bracket through a fluid channel, from the valve bracket to the distributor valve and the relay valve. From there it can pass back to the valve bracket and through the brake pipe to the brakes. In order to enable a modular construction of the control valve, optionally all housing compartments can be in fluid communication via a standardized interface. As a new generation of control valves was developed, some housing compartments or modules, that may need to be integrated in the control valve, can have a different interface, in particular a new standardized interface. For example a monitoring system was developed, that can monitor and check different parameters in the control valve and the pipe system in order to provide a reliable brake system. This monitoring system has a new standardized interface that is not compatible with the standardized interface of the existing control valve.

According to disclosed embodiments, the interface adapter may comprise a fluid interface duplicate for enabling fluid communication between the housing compartments of the control valve through the interface adapter. The fluid interface duplicate therefore matches the fluid interface of the housing compartments of the existing control valve, in particular the standardized interface of the existing control valve. This allows to place the interface adapter between the housing compartments without interrupting the fluid flow and hence the fluid communication and without having to change the existing, in particular standardized, fluid interface design.

The interface adapter also comprises a further interface being in fluid communication with the fluid interface duplicate for enabling access to the fluid communication between the housing compartments from outside the housing, in particular to enable fluid communication with the additional module and/or housing compartment that needs to be integrated. The additional module or housing compartment is optionally connected, in particular mounted, to the further interface. The two interfaces of the interface adapter can be designed independently from each other and can easily be adapted to specific requirements. Thus, the further interface can be adapted as required to be compatible with the interface of an additional module and/or housing compartment that is not compatible with the standardized interface of the control valve. For example the further interface can be adapted to the new standardized interface of the monitoring system.

The further interface of the interface adapter is in fluid communication with the fluid interface duplicate so it is also in fluid communication with the fluid interface between the housing compartments of the control valve. Thus, the further interface enables access to the fluid communication between the housing compartments from outside the housing to integrate an additional module or housing compartment. For example the fluid communication between the housing compartments can be accessed by a monitoring system with a standardized interface of the new generation of control valves. In this embodiment the interface adapter can adapt the old standardized interface of the existing control valve to the new standardized interface of the new generation of control valves. So it enables a mechanical implementation of the monitoring system as a retrofit solution to upgrade the existing control valve. It also provides a standardized interface across all valve products, especially across existing control valves and the new generation of control valves, because the same housing compartments and/or modules, for example the monitoring system, can be integrated in all control valves.

The monitoring system can check and monitor different parameters in order to provide a reliable brake system. The parameters may be related to the flow and/or pressure of the fluid at various points in the control valve or the pipe system. Other parameters may include but are not limited to temperature, moisture or vibrations at various points in the control valve or the pipe system. It is also possible to monitor one or more further pressures and/or one or more further other parameters. In an example embodiment there are various pressures that need to be monitored by the monitoring system in order to provide a reliable brake system. These include but are not limited to the pressures of an auxiliary reservoir and an emergency reservoir of the control valve, a relay valve arrangement, a brake cylinder, a brake pipe and a distributor valve. In this embodiment an interface adapter, according to the disclosed embodiments enables easy access to all pressures that need to be monitored by the monitoring system, as they can be accessed from outside the housing via the further interface that is in fluid communication with the fluid interface duplicate and hence the fluid interface between the housing compartments.

In an example embodiment the interface adapter comprises an essentially even plate structure. The plate structure has a fluid interface duplicate plate section and a further interface plate section. The fluid interface duplicate plate section and the further interface plate section extend in the same plane and/or are manufactured in one peace. In this embodiment the interface adapter, in particular an intermediate plate, provides a simple mechanical solution to integrate the monitoring system as a retrofit solution to existing control valves.

In another example embodiment, the interface adapter is configured to branch off the fluid communication in a direction at least section wisely parallel to the fluid interface between the housing compartments. This allows placing the further interface at a certain distance to the fluid interface duplicate at a better accessible position or at a position where the additional module and/or housing compartment connected to the interface adapter, for example the monitoring system, does not interfere with the housing compartments of the control valve or other components of the brake system next to the control valve. Thus, it allows using the limited installation space, especially in rail car pneumatic brake systems, in an optimal way. In an example embodiment the monitoring system can be placed next to an existing housing compartment instead of being mounted on the housing compartment. This reduces the installation space needed for the control valve.

In a further example embodiment, the fluid interface duplicate of the interface adapter comprises at least one through hole, optionally at least two, three, four, five, six, seven or eight through holes, for enabling distinct fluid flows through the interface adapter. The fluid interface duplicate can also comprise one or more further through holes to enable distinct fluid flows through the interface adapter. In this embodiment the further interface comprises a number of openings adapted to the number of through holes of the fluid interface duplicate. In an example embodiment the number of through holes of the fluid interface duplicate and the number of openings of the further interface can be adapted to the number of pressures that need to be monitored by the monitoring system. The further interface may also comprise one ore more openings for a breather and safety valve to balance the internal pressures of the control valve with the environment and to release internal over pressure if for example a pipe bursts.

In a further development each opening of the further interface is in fluid communication with one through hole of the fluid interface duplicate. The through holes enable an uninterrupted fluid flow between the housing compartments of the control valve. The fluid communication between each through hole and each opening enables access to the fluid flow between the housing compartments from outside the housing, for example by a monitoring system.

Optionally, the fluid communication between each opening and through hole is realized by a fluid channel extending through the interface adapter, in particular the plate structure, or a groove arranged on an outer surface of the interface adapter, in particular the plate structure. Such an embodiment has the advantage that there is no need for pipes to enable fluid communication between the fluid interface of the housing compartments and an additional module or housing compartment, for example the monitoring system.

According to another aspect of the disclosed embodiments that can be combined with previous aspects and example embodiments, a control valve, particularly for a rail car pneumatic brake system, comprises a housing with at least two housing compartments. The housing can also comprise one or more further housing compartments. The housing compartments are in fluid communication with each other via a fluid interface. The control valve according to disclosed embodiments further comprises an interface adapter configured to transfer the fluid interface of the housing compartments to an accessible space outside the housing for enabling a further access to the fluid communication, for example by a monitoring system. Thus, the control valve provides a mechanical solution to integrate the monitoring system in existing control valves as a retrofit solution to upgrade the existing control valve. It also provides a standardized interface across all valve products, especially across existing control valves and new generation control valves.

In an example embodiment the control valve comprises an interface adapter according to one of the previous aspects or example embodiments to make use of the advantages described above.

In a further example embodiment, the interface adapter is configured to transfer the fluid interface in a direction at least section wisely parallel to the interface between the housing compartments. This allows placing the further access to the fluid communication at a certain distance to the fluid interface at a better accessible position or at a position that offers more installation space to integrate an additional module and/or housing compartment, for example a monitoring system. Thus, it allows using the limited installation space, especially in rail car pneumatic brake systems, in an optimal way.

Optionally the further interface of the interface adapter is an electronics interface configured to be connected to an electronic module or a dummy for occupying the electronics interface. Optionally the electronic module is mounted to the interface adapter, in particular to the electronics interface. Optionally the electronic module or the dummy are mounted in an easy detachable way, for example by screws. This embodiment has the advantage that it provides a modular construction of the control valve, wherein either an electronic module or a dummy can be connected to the same electronics interface of the interface adapter. The dummy is needed in brake systems without an electronic module, to close the openings of the electronics interface in order to prevent air from getting into the brake system. The dummy optionally comprises an essentially even plate structure.

In another example embodiment the electronic module comprises a measuring and/or monitoring device, in particular a data hub, configured to determine and/or monitor at least one parameter of the fluid flow, such as a pressure. The measuring and/or monitoring device can also determine and/or monitor one or more further parameters of the fluid flow, such as a pressure. Other parameters that can be determined and/or monitored can include but are not limited to temperature, vibrations and/or moisture. In an example embodiment the pressures that need to be measured and/or monitored include the pressures of an auxiliary reservoir and an emergency reservoir of the control valve, a relay valve arrangement, a distributor valve, a brake cylinder and a brake pipe.

In a further development, the measuring and/or monitoring device, in particular the data hub, comprises a predetermined sensor arrangement of at least one sensor, in particular a pressure sensor. The predetermined sensor arrangement can also comprise one or more further sensors, in particular one or more further pressure sensors. The predetermined sensor arrangement can further include additional temperature sensors, accelerometers and/or moisture sensors. The data hub helps to integrate the data from all sensors and to process it. It can also transmit the data to a processing unit wirelessly or by wire. Optionally the electronics interface design is adapted to the predetermined sensor arrangement.

Optionally the pressure sensors of the predetermined sensor arrangement are each allocated to one electronics interface opening, enabling easy access to all parameters, for example all pressures, that need to be monitored in order to provide a reliable brake system.

In a particular embodiment of the control valve, each of the housing compartments comprises or is connected to a valve arrangement, such as a distributor valve or a relay valve arrangement. The relay valve arrangement comprises one or more relay valves that can quickly increase or decrease the air pressure. They help to shorten the pressure application time of the brake cylinders and also function as quick exhaust valves when the brakes are released.

In a further development, the further interface comprises a connection, such as an opening or a hole, for connecting to a fluid pipe enabling fluid communication of the further interface with the relay valve arrangement, in particular for enabling access to the control pressure of the relay valve arrangement.

In the following description, a control valve is generally indicated with the reference numeral 1.

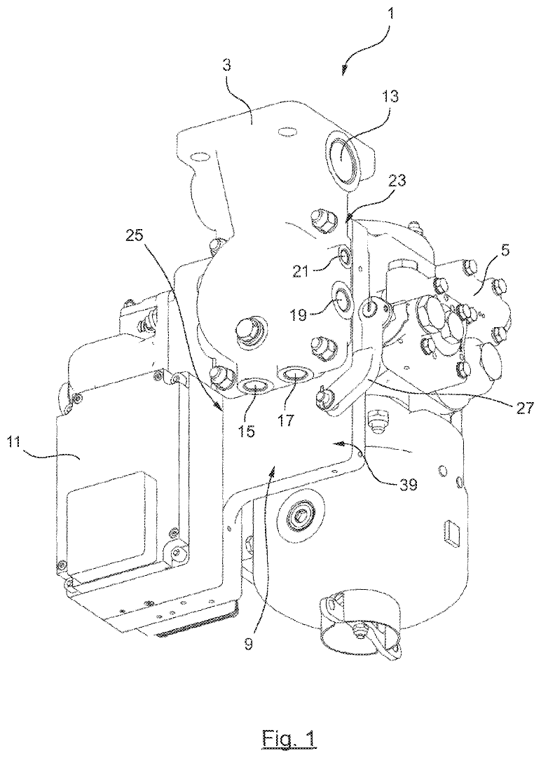

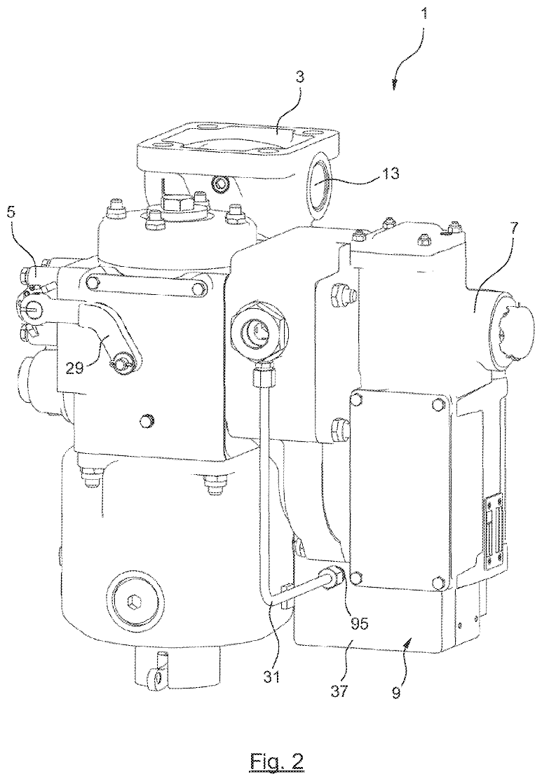

FIG. 1 and FIG. 2 show a control valve 1, particularly of a rail car pneumatic brake system, with a modular construction to be able to adapt the control valve 1 as flexibly as possible to potential requirements. It comprises three housing compartments 3, 5, 7.

The first housing compartment, a valve bracket 3, is configured to hold the other two housing compartments 5, 7 and/or to mount the control valve 1 for example to a chassis structure of a rail car and to connect the control valve 1 to other components of the brake system. The valve bracket 3 comprises a fluid channel 13 to guide the fluid, in particular the air stream of compressed air from the pneumatic brake system, into the control valve 1. It further comprises various pressure inlets and outlets 15, 17, 19, 21, in particular one pressure outlet and three pressure inlets, to enable fluid communication with a pipe system that is connected to other components of the brake system (not shown in FIG. 1 and FIG. 2). The pipe system connects the control valve 1 with the brakes, wherein the brake pipe leads the air stream from the control valve 1 to the brakes, as well as the emergency reservoir, the auxiliary reservoir and the brake cylinder, wherein the pipes lead the air stream to the control valve 1.

The other two housing compartments each comprise a module of the control valve 1. The second housing compartment 5 comprises a distributor valve and the third housing compartment 7 comprises a relay valve arrangement comprising one relay valve. There may also be a second relay valve adjacent to the first relay valve.

At least two of the three housing compartments 3, 5, 7, in particular all three housing compartments 3, 5, 7 are in fluid communication with each other via a standardized fluid interface 23. Via this fluid interface 23 the air stream coming into the valve bracket 3 through the fluid channel 13 can pass from the valve bracket 3 to the distributor valve 5 and the relay valve 7. From there it can pass back to the valve bracket 3 and through the brake pipe to the brakes.

The control valve 1 further comprises an interface adapter, generally indicated with the reference numeral 9 which, in the example embodiments of FIGS. 1 to 4, is formed as an intermediate plate 9 with an even plate structure. The intermediate plate 9 is placed between the valve bracket 3 and the other two housing compartments comprising the distributor valve 5 and the relay valve 7. All three housing compartments 3, 5, 7 are connected to the intermediate plate 9 in an easy detachable way. The valve bracket 3 and the housing compartment comprising the relay valve 7 are mounted on the intermediate plate 9 by screws. The housing compartment comprising the distributor valve 5 is mounted on the intermediate plate 9 by screws and two control levers 27, 29.

The intermediate plate 9 is needed to integrate an additional module, an electronic module, into the control valve 1 in particular without having to amend the interface structures and/or designs of the control valve and/or the additional module. This electronic module is a monitoring system 11, that can measure and/or monitor different parameters in the control valve 1 and the pipe system in order to provide a reliable pneumatic brake system. In particular the monitoring system 11 measures different pressures in the control valve 1 and the pipe system. These are the four pressures in the pipe system being in fluid communication with the valve bracket 3 (not shown in FIG. 1 and FIG. 2) as well as the pressures of the fluid streams between the valve bracket 3 and the distributor valve 5 as well as between the valve bracket 3 and the relay valve 7. The monitoring system 11 comprises a predetermined sensor arrangement with one pressure sensor for each pressure that needs to be monitored. The monitoring system also comprises a data HUB to integrate the data from all sensors, to process and transmit it. The monitoring system 11 is mounted to the intermediate plate 9 by screws.

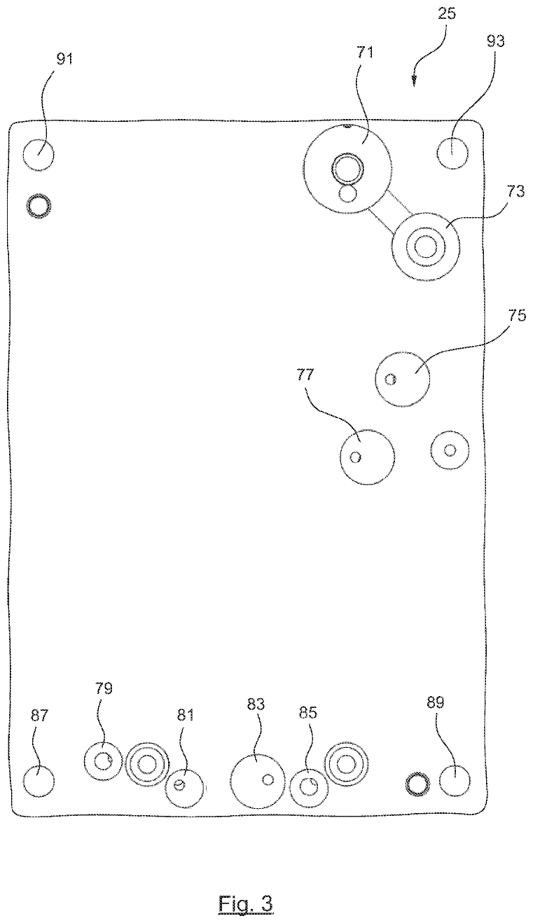

The fluid interface of the monitoring system 11 is optionally designed to be implemented in a new generation of control valves setting a new standard fluid interface. Therefore it has a new standardized fluid interface, a sensor interface 25 (FIG. 3), that is not compatible with the standardized fluid interface 23 of the housing compartments 3, 5, 7.

The control valve 1 further comprises an additional fluid pipe 31 that connects an opening 95 on the back side 37 of the intermediate plate 9 and the relay valve 7 to access the control pressure of the relay valve 7.

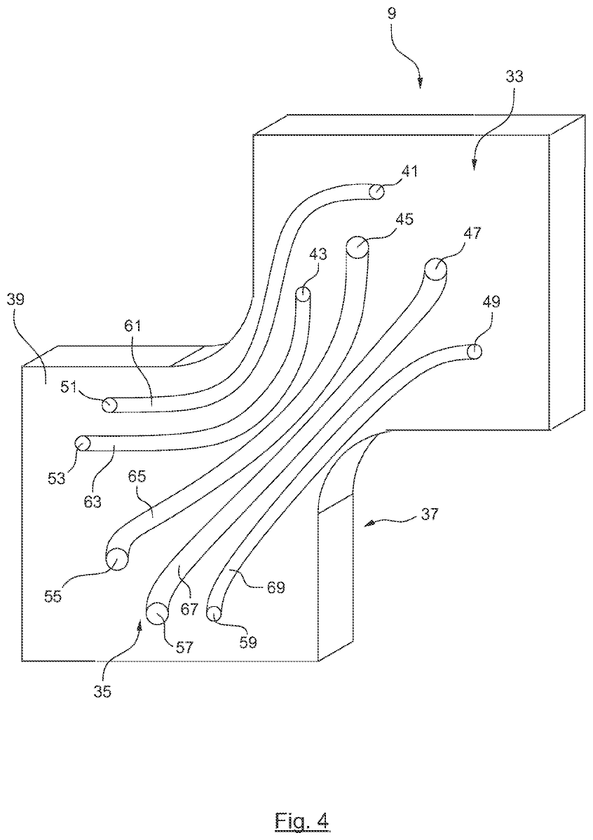

The intermediate plate 9 enables fluid communication between the monitoring system 11 and the housing compartments 3, 5, 7 of the control valve 1 and therefore provides a mechanical solution to integrate the monitoring system in an existing control valve 1 as a retrofit solution to upgrade the control valve 1. It also enables easy access to all pressures that need to be monitored by the monitoring system 11, because they can be accessed from outside the housing compartments 3, 5, 7. FIG. 4 schematically shows the front side 39 of the intermediate plate 9 to explain how the intermediate plate 9 works.

The front side 39 of the intermediate plate 9 comprises two fluid interface plate sections that extend in the same plane and are manufactured in one piece. Each of the fluid interface plate sections comprises a fluid interface. The first fluid interface is a fluid interface duplicate 33 that is compatible with the standardized interface 23 of the valve bracket 3 and the housing compartments comprising the distributor valve 5 and the relay valve 7. The fluid interface plate section 33 is placed between the housing compartments 3, 5, 7. It comprises a number of through holes 41, 43, 45, 47, 49 to enable uninterrupted fluid communication between the housing compartments 3, 5, 7 of the control valve 1 through the intermediate plate 9. The second fluid interface, the further fluid interface 35, is an electronics interface that is compatible with the predetermined sensor interface 25 of the monitoring system 11. The further interface 35 comprises a number of openings 51, 53, 55, 57, 59 adapted to the number of through holes 41, 43, 45, 47, 49 of the fluid interface duplicate 33. The monitoring system H is mounted on the further fluid interface plate section 35.

The fluid interface duplicate 33 and the further interface 35 are in fluid communication with each other. This means that that the monitoring system 11 in fluid communication with the further interface 35 is also in fluid communication with the fluid communication between the housing compartments 3, 5, 7. To enable this fluid communication each opening 51, 53, 55, 57, 59 of the further interface 35 is in fluid communication with one through hole 41, 43, 45, 47, 49 of the fluid interface duplicate 33. The fluid communication is realized by a number of grooves, notches or channels 61, 63, 65, 67, 69. The grooves are arranged on an outer surface 37 of the intermediate plate 9. It is also possible that the channels 61, 63, 65, 67, 69 extend through the solid material of the intermediate plate 9 and are not accessible from the outside along their extension. There is one groove for each through hole of the fluid interface duplicate 33 enabling the fluid communication with the corresponding opening of the further interface 35. For example the through hole 41 is in fluid communication with the opening 51 via the groove 61.

The intermediate plate 9 branches off the fluid communication parallel to the standardized fluid interface 23 between the valve bracket 3 and the housing compartments comprising the distributor valve 5 and the relay valve 7 by the grooves 61, 63, 65, 67, 69. This allows placing the further interface 35 at a position where it can be easily accessed by the monitoring system 11. It also allows placing the monitoring system 11 at any position in the limited installation space to prevent interference with the housing compartments 3, 5, 7 of the control valve 1 or other components of the brake system. In particular FIG. 1 shows that the monitoring system 11 is placed next to the valve bracket 3 instead of being mounted on the valve bracket 3, reducing the installation space needed for the control valve 1.

FIG. 3 shows the actual interface of the monitoring system 11, the sensor interface 25. As described above it has a number of openings adapted to the number of pressures that need to be monitored by the monitoring system 11. The openings are adapted to the predetermined sensor arrangement of the monitoring system 11, wherein each pressure sensor is allocated to one opening of the sensor interface 25. There are two openings for the distributor valve 5 (79, 81), to monitor the pressure of the air flow between the valve bracket 3 and the distributor valve 5. There are also two openings for the relay valve 7 (75, 77) to monitor the air flow between the valve bracket 3 and the relay valve 7. If the control valve 1 comprises a second relay valve adjacent to the first relay valve 7, the sensor interface 25 comprises two further openings adjacent to the openings 75, 77 for the first relay valve 7. The openings of the sensor interface 25 also enable fluid communication with the pipe system. There is one opening each for the pressure of the brake pipe (79) leading the air stream from the valve bracket 3 to the brakes and the pressures of the brake cylinder (75), the pre-control pressure (81), the emergency reservoir (83) and the auxiliary reservoir (35), wherein the pipes lead the air stream to the valve bracket 3.

Further the sensor interface 25 comprises two openings 71, 73 for a breather and safety valve (not shown) to balance the internal pressures of the control valve 1 with the environment and to release internal over pressure if for example a pipe bursts.

Further there are four holes 87, 89, 91, 93 to mount the monitoring system 11 on the sensor interface 25. In an alternative embodiment (not shown) a dummy, optionally a dummy plate can be mounted to the sensor interface 25. The dummy plate prevents air from getting into the brake system in brake systems without a monitoring system.

It should be clear that the sensor interface 25 in FIG. 3 is only one example of an electronics interface adapted to an exemplary monitoring system 11 to explain the function of such an electronics interface. In another example of an electronics interface, the interface could comprise more or less openings to monitor more or less pressures or other parameters and/or the openings could be arranged in a different way.

The features disclosed in the above description, the figures and the claims may be significant for the realization of the disclosed embodiments individually as in any combination.

### REFERENCE SIGN LIST

1 con troll valve
3 valve bracket
5 housing compartment comprising a distributor valve
7 housing compartment comprising a relay valve
9 intermediate plate
11 monitoring system
13 fluid channel
15, 17, 19, 21 pressure inlets and outlets of the valve bracket
23 standardized fluid interface of the existing control valve
25 sensor interface
27, 29 control levers
31 additional fluid pipe
33 fluid interface duplicate
35 further interface
37 Back side of the intermediate plate
39 Front side of the intermediate plate
41, 43, 45, 47, 49 through holes of the fluid interface duplicate
51, 53, 55, 57, 59 openings of the further interface
61, 63, 65, 67, 69 grooves
71, 73 openings for a breather and safety valve
75, 37 openings for the relay valve
79, 81 openings for the distributor valve
83 opening for the emergency reservoir
85 opening for the auxiliary reservoir
87, 89, 91, 93 holes to mount the monitoring system 95 opening to connect the additional fluid pipe

1. An interface adapter for a control valve of a rail car pneumatic brake system, the control valve having at least two housing compartments being in fluid communication with each other via a fluid interface, the interface comprising:
a fluid interface duplicate for enabling fluid communication between the housing compartments through the interface adapter; and
a further interface being in fluid communication with the fluid interface duplicate for enabling access to the fluid communication between the housing compartments from outside the housing.

2. The interface adapter of claim 1, further comprising:
a substantially even plate structure having a fluid interface duplicate plate section; and
a further interface plate section,
wherein the fluid interface duplicate plate section and the further interface plate section extended in the same plane and: or are manufactured in one piece.

3. The interface adapter of claim 1, wherein the interface adapter is configured to branch off the fluid communication in a direction at least section wisely parallel to the fluid interface.

4. The interface adapter of claim 1, wherein the fluid interface duplicate comprises at least one through hole enabling distinct fluid flows through the interface adapter and the further interface comprises a number of openings adapted to the number of through holes.

5. The interface adapter of claim 4, wherein each opening is in fluid communication with one through hole.

6. The interface adapter of claim 5, wherein the fluid communication between the opening and the through hole is a fluid channel extending through the plate structure or a groove arranged on an outer surface of the interface adapter.

7. A control valve, for a rail car pneumatic brake system, the control valve comprising:
a housing with at least two housing compartments being in fluid communication with each other via a fluid interface; and
an interface adapter configured to transfer the fluid interface to an accessible space outside the housing for enabling a further access to the fluid communication.

8. The control valve of claim 7, wherein the interface adapter, the control valve comprising
a fluid interface duplicate for enabling fluid communication between the housing compartments through the interface adapter; and
a further interface being in fluid communication with the fluid interface duplicate for enabling access to the fluid communication between the housing compartments from outside the housing.

9. The control valve of claim 7, wherein the interface adapter is configured to transfer the fluid interface in a direction at least section wisely parallel to the interface between the two housing compartments.

10. The control valve of claim 9, wherein the further interface is an electronics interface configured to be connected to an electronic module or a dummy for occupying the electronics interface, wherein, the electronic module is mounted to the electronics interface.

11. The control valve of claim 10, wherein the electronic module comprises a measuring and/or monitoring device, configured to determine and/or monitor at least one parameter of the fluid flow.

12. The control valve of claim 11, wherein the measuring and/or monitoring device comprises a predetermined sensor arrangement of at least one pressure sensor, and the electronics interface design is adapted to the predetermined sensor arrangement.

13. The control valve of claim 12, wherein the at least one pressure sensor of the predetermined sensor arrangement is allocated to one electronics interface opening.

14. The control valve of claim 7, wherein each of the housing compartments comprises or is connected to a distributor valve or a relay valve arrangement.

15. The control valve of claim 14, wherein the further interface comprises an opening, connection, for connecting to a fluid pipe enabling fluid communication of the further interface with the relay valve arrangement to provide access to the control pressure f.
